(19) United States
(12) Patent Application Publication
(10) Pub. No.: US 2021/0163667 A1
(43) Pub. Date: Jun. 3, 2021

(54) CURABLE COMPOSITION COMPRISING AN ACETAL PLASTICIZER

(71) Applicant: SIKA TECHNOLOGY AG, Baar (CH)

(72) Inventors: Andreas KRAMER, Zürich (CH); Urs BURCKHARDT, Zürich (CH); Rita CANNAS, Dübendorf (CH)

(73) Assignee: SIKA TECHNOLOGY AG, Baar (CH)

(21) Appl. No.: 16/772,922

(22) PCT Filed: Jan. 24, 2019
(86) PCT No.: PCT/EP2019/051750

§ 371 Date: Jun. 15, 2020

(30) Foreign Application Priority Data
Jan. 26, 2018 (EP) 18153702.8

(51) Int. Cl. C08G 18/50; C08G 18/30; C08G 18/16; C08G 18/75; C08G 18/48; C08K 5/06

(52) U.S. Cl. CPC C08G 18/5096; C08G 18/307; C08G 18/16; C08G 18/755; C08G 2170/00; C08G 18/5036; C08K 5/06; C08G 2150/00; C08G 18/4845

(57) ABSTRACT

Curable compositions include at least one organic polymer which contains silane groups and/or isocyanate groups, at least one compound which contains acetal groups and has a molecular weight of at least 280 g/mol, and at least one basic catalyst. The composition is particularly storage-stable and can be readily processed. Using moisture the composition cures rapidly, and with very little residual tackiness, to form a resilient material that has good adhesive and mechanical properties, in particular a high level of malleability and elasticity, is heat resistant and exhibits hardly any odour formation or migration effects. In particular, the composition has very consistent product properties during storage in respect of viscosity, curing rate and odour.

### TECHNICAL FIELD

The invention relates to curable compositions that are especially suitable as elastic adhesives, sealants or coatings.

### PRIOR ART

Room temperature moisture-curable compositions based on polymers containing silane groups and/or isocyanate groups play an important role in many industrial applications, especially as elastic adhesives, sealants or coatings. The usual way of improving the application properties of such compositions and increasing their elasticity is by adding what are called plasticizers thereto. These are nonvolatile organic substances that are not incorporated covalently into the polymer matrix in the course of curing. Customary plasticizers are esters of aromatic or aliphatic di- or tricarboxylic acids, especially phthalates such as diisononyl phthalate or diisodecyl phthalate, hydrogenated phthalates or cyclohexane-1,2-dicarboxylates, terephthalates, trimellitates, adipates, sebacates, succinates, citrates or similar esters.

Especially in compositions based on organic polymers containing silane groups, which are also referred to as “silane-functional polymers”, “silane-modified polymers” (SMPs) or “silane-terminated polymers” (STPs), however, such plasticizers often result in a change in the composition over time in the course of storage. This is particularly manifested in the form of an excessive increase in viscosity and/or altered curing characteristics after storage. An elevated viscosity makes it more difficult to apply the composition in that higher expression forces are required, the material is more difficult to pump or has lower creep resistance. Altered curing characteristics are manifested in shortening or lengthening of the skin time and/or the through-curing time. Such changes dependent on the storage time are highly undesirable since they lead to significant variations in product characteristics and make the product unpredictable for the user. They occur to an enhanced degree especially when the composition contains basic catalysts such as amines, amidines or guanidines. As well as altered application and curing properties, storage can also give rise to troublesome odors as a result of low molecular weight breakdown products that outgas from the composition.

Owing to widespread scepticism with respect to phthalates, there is additionally a desire for phthalate-free products. At the same time, however, many compounds that are used as an alternative to phthalate plasticizers, such as adipates or cyclohexane-1,2-dicarboxylates in particular, have only inadequate compatibility with the polymer matrix and have a tendency to migration. This leads to undesirable effects such as bleeding or staining, especially in the case of porous substrates, or softening, cracking, discoloration or loss of adhesion of the substrate or of a varnish or paint layer applied thereon.

Acetals are known in principle, for example from EP 959 086 or EP 1 318 179, where bis(2-phenoxyethyl) formal is used as thinner in two-component polyurethane varnishes. However, it is not apparent from these documents that such acetals are also used as plasticizers for moisture-curing elastic sealants and adhesives based on isocyanate- and/or silane-functional organic polymers containing basic catalysts, and in this case can assume the plasticizing function of customary phthalates without triggering problems with storage stability. Di- or polyfunctional acetal-capped polyether polyols are known, for example from U.S. Pat. No. 3,923,744, where they are used as latent polyols that are releasable again by means of moisture in coatings containing isocyanate groups.

### SUMMARY OF THE INVENTION

It is therefore an object of the present invention to provide a curable compositions that overcomes the disadvantages of the prior art in relation to the storage stability of moisture-curing compositions containing plasticizers and basic catalysts.

This object is achieved by a curable composition as described in claim 1. The composition is thinned and elastified surprisingly well by the compound containing acetal groups without increased incidence of migration effects.

Surprisingly, in the course of storage, it does not show any significant changes in product properties as observed in the case of compositions comprising phthalates. More particularly, it has very constant viscosity and curing rate over the storage time and does not evolve any troublesome odors. Furthermore, the stability of the cured composition to heat stress is surprisingly not only just as good but actually better by comparison with compositions containing phthalate plasticizers such as DIDP or DINP. The basic catalyst stabilizes the compound containing acetal groups, such that there is no redissociation to the alcohol on ingress of moisture.

The composition of the invention is particularly storage-stable and has good processibility. With moisture, it cures rapidly and with very low residual tack to give an elastic material having good adhesion and mechanical properties, especially high extensibility and elasticity, is heat-resistant and exhibits barely any odor formation or migration effects. More particularly, the composition has very constant product properties during the storage time in relation to viscosity, curing rate and odor.

Further aspects of the invention are the subject of further independent claims. Particularly preferred embodiments of the invention are the subject of the dependent claims.

Ways of executing the invention The invention provides a curable composition comprising
at least one organic polymer containing silane groups and/or isocyanate groups,
at least one compound containing acetal groups and having a molecular weight of at least 280 g/mol, and
at least one basic catalyst.

A “curable” composition refers to one that cures through crosslinking reactions of reactive groups present therein or can attain a state of elevated mechanical strength.

A “silane group” refers to a silyl group bonded to an organic radical and having one to three, especially two or three, hydrolyzable alkoxy radicals on the silicon atom.

“Silane” refers both to organoalkoxysilanes bearing one to three organic substituents on each silane group and tetraalkoxysilanes. Silanes that bear one or more hydroxyl, isocyanato, amino or mercapto groups in addition to the silane group on an organic radical are referred to as “hydroxysilane”, “isocyanatosilane”, “aminosilane” and “mercaptosilane” respectively. “Acetal group” refers to the geminal diether group of an acetal. “Acetal” refers to geminal diethers, i.e. compounds having two alkoxy or aryloxy groups on the same carbon atom. Acetal also refers to ketals. “Molecular weight” refers to the molar mass (in g/mol) of a molecule or a molecule residue. “Average molecular weight” refers to the number-average molecular weight (Mₙ) of a polydisperse mixture of oligomeric or polymeric molecules or molecule residues. It is typically determined by means of gel permeation chromatography (GPC) against polystyrene as standard.

Substance names beginning with “poly”, such as polyamine, polyol or polyisocyanate, refer to substances containing, in a formal sense, two or more of the functional groups that occur in their name per molecule.

A composition referred to as “storage-stable” or “storable” is one that can be stored at room temperature in a suitable container over a prolonged period, typically over at least 3 months up to 6 months or more, without this storage resulting in any change in its application or use properties to an extent relevant to its use.

A dotted line in the formulae in this document in each case represents the bond between a substituent and the corresponding molecule radical. “Room temperature” refers to a temperature of about 23° C.

Preferably, the curable composition cures with moisture, preferably air humidity. Such a composition is also referred to as “moisture-curing”.

The organic polymer containing silane groups and/or isocyanate groups preferably has an average molecular weight, determined by means of GPC against polystyrene as standard, in the range from 1000 to 30′000 g/mol, especially from 2000 to 20′000 g/mol.

It is preferably liquid at room temperature.

It preferably contains an average of 1.1 to 4, preferably 1.2 to 3, more preferably 1.5 to 3, especially 1.7 to 2.8, silane groups and/or isocyanate groups per molecule.

It preferably includes proportions of polyether structural units, especially mainly polyoxypropylene structural units. Such a composition is particularly extensible and elastic.

In a preferred embodiment, the organic polymer containing silane groups and/or isocyanate groups is free of isocyanate groups. Such a curable composition thus contains at least one organic polymer containing silane groups. Such a polymer is also referred to as “silane-modified polymer” (SMP), and such a composition is also referred to as an SMP composition.

The organic polymer containing silane groups preferably has silane groups of the formula

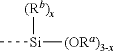

where
R^{a} is a linear or branched, monovalent hydrocarbyl radical having 1 to 5 carbon atoms, especially methyl or ethyl,
R^{b} is a linear or branched monovalent hydrocarbyl radical having 1 to 8 carbon atoms, especially methyl, and
x has a value of 0 or 1 or 2, preferably 0 or 1, especially 0.

Methoxysilane groups have the advantage here that they are particularly reactive. Ethoxysilane groups have the advantage that they are toxicologically advantageous and particularly storage-stable.

Particular preference is given to trimethoxysilane groups, dimethoxymethylsilane groups or triethoxysilane groups.

Most preferred are trimethoxysilane groups or triethoxysilane groups.

A preferred organic polymer containing silane groups is a polyolefin or a polyester or a polyamide or a poly(meth)acrylate or a polyether or a mixed form of these polymers. The silane groups may be in pendant positions in the chain or in terminal positions and are bonded to the organic polymer via a carbon atom.

More preferably, the organic polymer containing silane groups is a polyether containing silane groups.

“Polyethers containing silane groups” refer to organic polymers containing at least one silane group, wherein the polymer chain has mainly polyether units, especially 1,2-oxypropylene units. As well as the polyether units, it is especially also possible for there to be urethane groups, urea groups, thiourethane groups, ester groups or amide groups.

The polyether containing silane groups preferably contains at least 50% by weight, especially at least 70% by weight, more preferably at least 80% by weight, of 1,2-oxypropylene units.

Processes for preparing suitable polyethers containing silane groups are known to the person skilled in the art.

In a preferred process, polyethers containing silane groups are obtainable from the reaction of polyethers containing allyl groups with hydrosilanes, optionally with chain extension using diisocyanates for example.

In a further preferred process, polyethers containing silane groups are obtainable from the copolymerization of alkylene oxides and epoxysilanes, optionally with chain extension using diisocyanates for example.

In a further preferred process, polyethers containing silane groups are obtainable from the reaction of polyether polyols with isocyanatosilanes, optionally with chain extension using diisocyanates.

In a further preferred process, polyethers containing silane groups are obtainable from the reaction of polyethers containing isocyanate groups with aminosilanes, hydroxysilanes or mercaptosilanes. Polyethers containing silane groups from this process are particularly preferred. This process enables the use of a multitude of commercially readily available inexpensive starting materials by means of which different polymer properties are obtainable, especially high extensibility, high strength, low modulus of elasticity, low glass transition temperature or high weathering resistance.

More preferably, the polyether containing silane groups is obtainable from the reaction of polyethers containing isocyanate groups with aminosilanes and/or hydroxysilanes and/or mercaptosilanes.

Suitable polyethers containing isocyanate groups are especially obtainable from the reaction of polyether polyols, especially polyoxyalkylene diols or polyoxyalkylene triols, preferably polyoxypropylene diols or polyoxypropylene triols, with a superstoichiometric amount of polyisocyanates, especially diisocyanates.

It is preferable when the reaction between the polyisocyanate and the polyether polyol is conducted with exclusion of moisture at a temperature of 50° C. to 160° C., optionally in the presence of suitable catalysts, wherein the polyisocyanate has been dosed such that the isocyanate groups thereof are present in a stoichiometric excess in relation to the hydroxyl groups of the polyol. In particular, the excess of polyisocyanate is chosen so as to leave, after the reaction of all hydroxyl groups, a content of free isocyanate groups of 0.1% to 5% by weight, preferably 0.2% to 4% by weight, particularly preferably 0.3% to 3% by weight, based on the overall polymer.

Preferred diisocyanates are the same as those mentioned for the preparation of polymers containing isocyanate groups. Particular preference is given to IPDI or TDI. Most preferred is IPDI. In this way, polyethers containing silane groups with particularly good lightfastness are obtained.

Especially suitable as polyether polyols are polyoxypropylenediols having a degree of unsaturation lower than 0.02 meq/g, especially lower than 0.01 meq/g, and an average molecular weight in the range from 400 to 25′000 g/mol, especially 1′000 to 20′000 g/mol.

In addition to polyether polyols it is also possible to use proportions of other polyols, especially polyacrylate polyols and low molecular weight diols or triols.

Suitable aminosilanes for the reaction with a polyether containing isocyanate groups are primary and secondary aminosilanes. Preference is given to 3-aminopropyltrimethoxysilane, 3-aminopropyldimethoxymethylsilane, 4-aminobutyltrimethoxysilane, 4-amino-3-methylbutyltrimethoxysilane, 4-amino-3,3-dimethylbutyltrimethoxysilane, N-butyl-3-aminopropyltrimethoxysilane, N-phenyl-3-aminopropyltrimethoxysilane, adducts formed from primary amino-silanes such as 3-aminopropyltrimethoxysilane, 3-aminopropyldimethoxymethylsilane or N-(2-aminoethyl)-3-aminopropyltrimethoxysilane and Michael acceptors such as acrylonitrile, (meth)acrylic esters, (meth)acrylamides, maleic or fumaric diesters, citraconic diesters or itaconic diesters, especially dimethyl or diethyl N-(3-trimethoxysilylpropyl)aminosuccinate. Likewise suitable are analogs of the recited aminosilanes with ethoxy groups in place of the methoxy groups on the silicon.

Suitable hydroxysilanes for the reaction with a polyether containing isocyanate groups are especially obtainable from the addition of aminosilanes onto lactones or onto cyclic carbonates or onto lactides.

Preferred hydroxysilanes that are obtained in this way are N-(3-triethoxysilylpropyl)-2-hydroxypropanamide, N-(3-trimethoxysilylpropyl)-2-hydroxypropanamide, N-(3-triethoxysilylpropyl)-4-hydroxypentanamide, N-(3-triethoxysilylpropyl)-4-hydroxyoctanamide, N-(3-triethoxysilylpropyl)-5-hydroxydecanamide or N-(3-triethoxysilylpropyl)-2-hydroxypropyl carbamate.

Further suitable hydroxysilanes are obtainable from the addition of aminosilanes onto epoxides or from the addition of amines onto epoxysilanes. Preferred hydroxysilanes which are obtained in this way are 2-morpholino-4(5)-(2-trimethoxysilylethyl)cyclohexan-1-ol, 2-morpholino-4(5)-(2-triethoxysilylethyl)cyclohexan-1-ol or 1-morpholino-3-(3-(triethoxysilyl)propoxy)propan-2-ol.

Suitable mercaptosilanes for the reaction with a polyether containing isocyanate groups are especially 3-mercaptopropyltrimethoxysilane or 3-mercaptopropyltriethoxysilane.

Further suitable polyethers containing silane groups are commercially available products, especially the following: MS Polymer™ (from Kaneka; especially the S203H, S303H, S227, S810, MA903 and S943 products); MS Polymer™ or Silyl™ (from Kaneka; especially the SAT010, SAT030, SAT200, SAX350, SAX400, SAX725, MAX450, MAX951 products); Excestar® (from Asahi Glass; especially the S2410, S2420, S3430, S3630 products); SPUR+* (from Momentive Performance Materials; especially the 1010LM, 1015LM, 1050MM products); Vorasil™ (from DowDuPont; especially the 602 and 604 products); Desmoseal® (from Covestro; especially the S XP 2458, S XP 2636, S XP 2749, S XP 2774 and S XP 2821 products), TEGOPAC® (from Evonik; especially the Seal 100, Bond 150, Bond 250 products), Polymer ST (from Hanse Chemie/Evonik, especially the 47, 48, 61, 61LV, 77, 80, 81 products); Geniosil® STP (from Wacker; especially the E10, E15, E30, E35 products).

More preferably, the polyether containing silane groups is obtained from the reaction of at least one polyether containing isocyanate groups with at least one aminosilane and/or hydroxysilane and/or mercaptosilane.

Preferably, the aminosilane and/or hydroxysilane and/or mercaptosilane here is selected from the group consisting of dimethyl N-(3-trimethoxysilylpropyl)aminosuccinate, diethyl N-(3-trimethoxysilylpropyl)aminosuccinate, dimethyl N-(3-triethoxysilylpropyl)aminosuccinate, diethyl N-(3-triethoxysilylpropyl)aminosuccinate, N-(3-trimethoxysilylpropyl)-2-hydroxypropanamide, N-(3-triethoxysilylpropyl)-2-hydroxypropanamide, 3-mercaptopropyltrimethoxysilane and 3-mercaptopropyltriethoxysilane.

The preferred embodiments of the organic polymer containing silane groups enable compositions having good storage stability, rapid curing and particularly good mechanical properties, especially high elasticity and extensibility coupled with good strength, and high heat resistance.

In a further preferred embodiment, the composition contains at least one polymer containing isocyanate groups. Such a composition is also referred to as “polyurethane composition”.

A suitable polymer containing isocyanate groups is especially obtained from the reaction of at least one polyol with a superstoichiometric amount of at least one polyisocyanate. The reaction is preferably carried out with exclusion of moisture at a temperature in the range from 50 to 160° C., optionally in the presence of suitable catalysts. The NCO/OH ratio is preferably in the range from 1.3/1 to 2.5/1. The polymer obtained preferably has a content of free isocyanate groups in the range from 0.5% to 10% by weight, especially 1% to 5% by weight, especially preferably 1% to 3% by weight. The polymer is optionally prepared with additional use of plasticizers or solvents, in which case the plasticizers or solvents used do not contain any groups reactive toward isocyanates.

Preferred polyisocyanates are aliphatic or cycloaliphatic diisocyanates, especially hexamethylene 1,6-diisocyanate (HDI), 2,2,4- or 2,4,4-trimethylhexamethylene 1,6-diisocyanate (TMDI), cyclohexane 1,3- or 1,4-diisocyanate, 1-isocyanato-3,3,5-trimethyl-5-isocyanatomethylcyclohexane (isophorone diisocyanate or IPDI), perhydrodiphenylmethane 2,4′- or 4,4′-diisocyanate (HMDI), 1,3- or 1,4-bis(isocyanatomethyl)cyclohexane, m- or p-xylylene diisocyanate (XDI), or mixtures thereof, especially HDI, IPDI, HMDI, or mixtures thereof.

Suitable polyisocyanates are also aromatic diisocyanates, especially tolylene 2,4- or 2,6-diisocyanate or any mixtures of these isomers (TDI), diphenylmethane 4,4′-, 2,4′- or 2,2′-diisocyanate or any mixtures of these isomers (MDI), phenylene 1,3-diisocyanate or phenylene 1,4-diisocyanate, or mixtures thereof, especially TDI or MDI.

Particular preference is given to aliphatic or cycloaliphatic diisocyanates, especially HDI or IPDI or mixtures thereof.

Suitable polyols are commercial polyols or mixtures thereof, especially
polyether polyols, especially polyoxyalkylenediols and/or polyoxyalkylenetriols, especially polymerization products of ethylene oxide or 1,2-propylene oxide or 1,2- or 2,3-butylene oxide or oxetane or tetrahydrofuran or mixtures thereof, where these may be polymerized with the aid of a starter molecule having two or more active hydrogen atoms, especially a starter molecule such as water, ammonia or a compound having multiple OH or NH groups, such as, for example, ethane-1,2-diol, propane-1,2- or -1,3-diol, neopentyl glycol, diethylene glycol, triethylene glycol, the isomeric dipropylene glycols or tripropylene glycols, the isomeric butanediols, pentanediols, hexanediols, heptanediols, octanediols, nonanediols, decanediols, undecanediols, cyclohexane-1,3- or -1,4-dimethanol, bisphenol A, hydrogenated bisphenol A, 1,1,1-trimethylolethane, 1,1,1-trimethylolpropane, glycerol or aniline, or mixtures of the abovementioned compounds. Likewise suitable are polyether polyols with polymer particles dispersed therein, especially those with styrene/acrylonitrile (SAN) particles or polyurea or polyhydrazodicarbonamide (PHD) particles.
Preferred polyether polyols are polyoxypropylene diols or polyoxypropylene triols, or what are called ethylene oxide-terminated (EO-capped) polyoxypropylene diols or triols. The latter are mixed polyoxyethylene/polyoxypropylene polyols which are especially obtained in that polyoxypropylene diols or triols, on conclusion of the polypropoxylation reaction, are further alkoxylated with ethylene oxide and thereby eventually have primary hydroxyl groups.
Preferred polyether polyols have a degree of unsaturation of less than 0.02 meq/g, especially less than 0.01 meq/g.
Polyester polyols, also called oligoesterols, prepared by known processes, especially the polycondensation of hydroxycarboxylic acids or lactones or the polycondensation of aliphatic and/or aromatic polycarboxylic acids with di- or polyhydric alcohols. Preference is given to polyester diols from the reaction of dihydric alcohols, such as, in particular, ethane-1,2-diol, diethylene glycol, propane-1,2-diol, dipropylene glycol, butane-1,4-diol, pentane-1,5-diol, hexane-1,6-diol, neopentyl glycol, glycerol, 1,1,1-trimethylolpropane or mixtures of the aforementioned alcohols, with organic dicarboxylic acids or the anhydrides or esters thereof, such as, in particular, succinic acid, glutaric acid, adipic acid, suberic acid, sebacic acid, dodecanedicarboxylic acid, maleic acid, fumaric acid, phthalic acid, isophthalic acid, terephthalic acid or hexahydrophthalic acid or mixtures of the aforementioned acids, or polyester polyols formed from lactones such as, in particular, c-caprolactone. Particular preference is given to polyester polyols from adipic acid or sebacic acid or dodecanedicarboxylic acid and hexanediol or neopentyl glycol.
Polycarbonate polyols as obtainable by reaction, for example, of the abovementioned alcohols—used to form the polyester polyols—with dialkyl carbonates, diaryl carbonates or phosgene.
Block copolymers bearing at least two OH groups and having at least two different blocks having polyether, polyester and/or polycarbonate structure of the type described above, especially polyether polyester polyols.
Polyacrylate or polymethacrylate polyols.
Polyhydroxy-functional fats or oils, for example natural fats and oils, especially castor oil; or polyols obtained by chemical modification of natural fats and oils—called oleochemical polyols—for example the epoxy polyesters or epoxy polyethers obtained by epoxidation of unsaturated oils and subsequent ring opening with carboxylic acids or alcohols, or polyols obtained by hydroformylation and hydrogenation of unsaturated oils; or polyols obtained from natural fats and oils by degradation processes, such as alcoholysis or ozonolysis, and subsequent chemical linkage, for example by transesterification or dimerization, of the degradation products or derivatives thereof thus obtained. Suitable degradation products of natural fats and oils are in particular fatty acids and fatty alcohols and also fatty acid esters, in particular the methyl esters (FAME), which can be derivatized to hydroxy fatty acid esters, for example by hydroformylation and hydrogenation.
Polyhydrocarbon polyols, also called oligohydrocarbonols, such as, in particular, polyhydroxy-functional polyolefins, polyisobutylenes, polyisoprenes; polyhydroxy-functional ethylene/propylene, ethylene/butylene or ethylene/propylene/diene copolymers, as produced, for example, by Kraton Polymers; polyhydroxy-functional polymers of dienes, especially of 1,3-butadiene, which can especially also be prepared from anionic polymerization; polyhydroxy-functional copolymers of dienes, such as 1,3-butadiene, or diene mixtures and vinyl monomers, such as styrene, acrylonitrile, vinyl chloride, vinyl acetate, vinyl alcohol, isobutylene or isoprene, especially polyhydroxy-functional acrylonitrile/butadiene copolymers, as can be prepared, in particular, from epoxides or aminoalcohols and carboxyl-terminated acrylonitrile/butadiene copolymers (commercially available, for example, under the Hypro® CTBN or CTBNX or ETBN name from Emerald Performance Materials); or hydrogenated polyhydroxy-functional polymers or copolymers of dienes.

Also especially suitable are mixtures of polyols.

Preference is given to polyether polyols, polyester polyols, polycarbonate polyols, poly(meth)acrylate polyols or polybutadiene polyols.

Particular preference is given to polyether polyols, especially polyoxyalkylenepolyols.

Most preferred are polyoxypropylenedi- or triols or ethylene oxide-terminated polyoxypropylenedi- or triols.

Preference is given to polyols having an average molecular weight in the range from 400 to 20′000 g/mol, preferably from 1000 to 15′000 g/mol.

Preference is given to polyols having an average OH functionality in the range from 1.6 to 3.

Preference is given to polyols that are liquid at room temperature.

In the preparation of a polymer containing isocyanate groups, it is also possible to use fractions of di- or polyfunctional alcohols, especially ethane-1,2-diol, propane-1,2-diol, propane-1,3-diol, 2-methylpropane-1,3-diol, butane-1,2-diol, butane-1,3-diol, butane-1,4-diol, pentane-1,3-diol, pentane-1,5-diol, 3-methylpentane-1,5-diol, neopentyl glycol, dibromoneopentyl glycol, hexane-1,2-diol, hexane-1,6-diol, heptane-1,7-diol, octane-1,2-diol, octane-1,8-diol, 2-ethylhexane-1,3-diol, diethylene glycol, triethylene glycol, dipropylene glycol, tripropylene glycol, cyclohexane-1,3- or -1,4-dimethanol, ethoxylated bisphenol A, propoxylated bisphenol A, cyclohexanediol, hydrogenated bisphenol A, dimer fatty acid alcohols, 1,1,1-trimethylolethane, 1,1,1-trimethylolpropane, glycerol, pentaerythritol, sugar alcohols, such as especially xylitol, sorbitol or mannitol, or sugars such as, in particular, sucrose, or alkoxylated derivatives of the alcohols mentioned or mixtures of the alcohols mentioned.

The polymer containing isocyanate groups preferably has an average molecular weight in the range from 1500 to 20′000 g/mol, especially 2000 to 15′000 g/mol.

The polymer containing isocyanate groups preferably has a content of isocyanate groups in the range from 1% to 5% by weight, preferably 1% to 3% by weight.

The polymer containing isocyanate groups preferably has aliphatic isocyanate groups. Such a composition together with the basic catalyst has good storage stability, cures rapidly and has the advantageous properties described.

In addition to a polymer comprising isocyanate groups, the composition may contain at least one diisocyanate and/or one oligomer or polymer of a diisocyanate, especially an IPDI isocyanurate or a TDI oligomer or a mixed isocyanurate based on TDI/HDI or an HDI oligomer or a form of MDI which is liquid at room temperature.

A form of MDI which is liquid at room temperature is either 4,4′-MDI liquefied by partial chemical modification—especially carbodiimidization or uretonimine formation or adduct formation with polyols—or it is a mixture of 4,4′-MDI with other MDI isomers (2,4′-MDI and/or 2,2′-MDI), and/or with MDI oligomers and/or MDI homologs (polymeric MDI or PMDI), that has been brought about selectively by blending or results from the production process.

Preferably, the composition, when it contains a polymer containing isocyanate groups, has a content of free isocyanate groups in the range from 0.2% to 2% by weight. A composition of this kind has high elasticity and extensibility.

More preferably, the organic polymer present in the composition is free of isocyanate groups. Such a composition is particularly advantageous in toxicological terms and particularly critical in relation to constant curing rate during storage time.

In addition, the curable composition contains at least one compound containing acetal groups and having a molecular weight of at least 280 g/mol.

The compound containing acetal groups is typically liquid at room temperature.

The compound containing acetal groups preferably has a molecular weight in the range from 280 to 10′000 g/mol, more preferably 280 to 5′000 g/mol, especially preferably 280 to 2′500 g/mol, in particular 280 to 1′500 g/mol.

The compound containing acetal groups preferably contains one to three, especially one or two, acetal groups.

Such preferred compounds containing acetal groups give good thinning of the curable composition without migrating or diffusing out of the composition to a high degree after application, and they improve the mechanical properties of the cured composition, especially lower the modulus of elasticity and increase extensibility.

The compound containing acetal groups is preferably a compound of the formula (I)

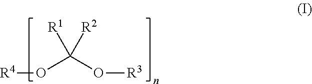

where
R¹ and R² are each independently H or an alkyl, cycloalkyl, aralkyl or aryl radical having 1 to 7 carbon atoms,
R³ is an alkyl, cycloalkyl or aralkyl radical optionally having ether groups and having 1 to 30 carbon atoms, or is a monovalent polyoxyalkylene radical having an average molecular weight in the range from 300 to 2′000 g/mol,
R⁴ is an n-valent alkyl, cycloalkyl or aralkyl radical optionally having ether groups and having 4 to 30 carbon atoms, or is an n-valent polyoxyalkylene radical having an average molecular weight in the range from 300 to 4′000 g/mol, and
n is 1 or 2 or 3,
where R¹ and R² may also together be an unbranched or branched alkylene radical having 4 to 12 carbon atoms and R² and R³ may also together be an unbranched or branched alkylene radical having 3 to 8 carbon atoms, and wherein the compound of the formula (I) has a molecular weight of at least 280 g/mol.

The compound of the formula (I) preferably has a molecular weight in the range from 280 to 5′000 g/mol, more preferably 280 to 2′500 g/mol, especially 280 to 1′500 g/mol.

Preferably, n is 1 or 2.

Preferably R¹ is H or methyl, especially H.

Preferably, R² is H or an alkyl radical having 1 to 7 carbon atoms, especially methyl.

Preferably, R³ is an alkyl, cycloalkyl or aralkyl radical having one or two ether groups and having 1 to 15 carbon atoms, especially methyl, ethyl, isopropyl, butyl, isobutyl, tert-butyl, hexyl, 2-ethylhexyl, allyl, cyclohexyl, benzyl or phenyl, isononyl, isodecyl, lauryl, 2-phenoxyethyl, 2-phenoxypropyl, 2-benzyloxyethyl, 1-(2-methoxy-1-methylethoxy)-2-propyl, 1-(2-methoxypropoxy)-2-propyl, 1-(2-butoxy-1-methylethoxy)-2-propyl, 1-(2-butoxypropoxy)-2-propyl.

Further preferably, R³ is a monovalent polyoxypropylene radical having an average molecular weight in the range from 300 to 2′000 g/mol.

If R¹ and R² together are an alkylene radical, they are preferably 1,4-butylene or 1,5-pentylene, especially 1,5-pentylene.

If R² and R³ together are an alkylene radical, they are preferably 1,3-propylene or 1,4-butylene, especially 1,4-butylene.

Preferably, R⁴ is an alkyl, cycloalkyl or aralkyl radical having one or two ether groups and having 4 to 15, especially 8 to 15, carbon atoms.

Further preferably, R⁴ is an n-valent polyoxyalkylene radical having an average molecular weight in the range from 300 to 4′000 g/mol, preferably 300 to 2′000 g/mol.

The polyoxyalkylene radicals are preferably polyoxypropylene radicals, or polyoxypropylene radicals additionally having oxyethylene units, especially polyoxypropylene radicals.

Such a compound of the formula (I) has particularly good compatibility with polymers that themselves have polyoxypropylene units, and does not result in elevated hydrophilicity of the composition.

The polyoxyalkylene radicals preferably contain at least 50% by weight, especially at least 70% by weight, more preferably at least 80% by weight, of 1,2-oxypropylene units.

Such a monovalent polyoxyalkylene radical preferably has an ether group as end group, especially a butyl ether group. Such compounds of the formula (I) are derived from alcohol-started, especially butanol-started, polyoxyalkylenemonools.

In a preferred compound of the formula (I), n is 1, R¹ and R² are each H, and R³ and R⁴ are each identical radicals.

R³ and R⁴ here are preferably each an alkyl, cycloalkyl or aralkyl radical optionally having one or two ether groups and having 6 to 15, especially 8 to 15, carbon atoms. Such a compound of the formula (I) is particularly easily obtainable and gives particularly good thinning of the composition.

In addition, R³ and R⁴ here are preferably each a monovalent polyoxypropylene radical optionally having ethylene oxide units and having an average molecular weight in the range from 300 to 2′000 g/mol. Such a compound of the formula (I) is particularly easily obtainable and is particularly compatible in the composition.

More preferably, R³ and R⁴ here are each identical radicals selected from isononyl, isodecyl, lauryl, 2-phenoxyethyl, 2-phenoxypropyl, 2-benzyloxyethyl, 1-(2-methoxy-1-methylethoxy)-2-propyl, 1-(2-methoxypropoxy)-2-propyl, 1-(2-butoxy-1-methylethoxy)-2-propyl, 1-(2-butoxypropoxy)-2-propyl and a 1-butanol-started polyoxypropylene radical having an average molecular weight in the range from 300 to 2′000 g/mol.

In particular, R³ and R⁴ here are each 2-phenoxyethyl. Such a compound of the formula (I) enables compositions of particularly low viscosity. It has the formula

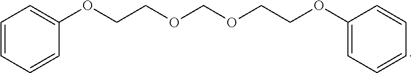 [SMILES: c1ccc(OCCOCOCCOc2ccccc2)cc1]

In particular, R³ and R⁴ here are additionally each a 1-butanol-started polyoxypropylene radical having an average molecular weight in the range from 300 to 2′000 g/mol. Such a compound of the formula (I) enables curable compositions with a particularly low level of migration effects. It has the formula

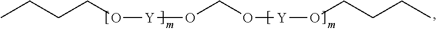

where Y is 1,2-propylene and m is an integer in the range from 3 to 35.

In a further preferred compound of the formula (I), n is 1, R¹ is H, R⁴ is a 1-butanol-started polyoxypropylene radical having an average molecular weight in the range from 650 to 2′000 g/mol, and either R² and R³ together are 1,3-propylene or 1,4-butylene or R² is methyl and R³ is methyl, ethyl, isopropyl, butyl, isobutyl, tert-butyl, hexyl, 2-ethylhexyl, allyl, cyclohexyl, benzyl or phenyl, preferably methyl, ethyl, isopropyl, butyl or isobutyl, especially isobutyl. Such a compound of the formula (I) enables curable compositions with a particularly low level of migration effects. It especially has the formula

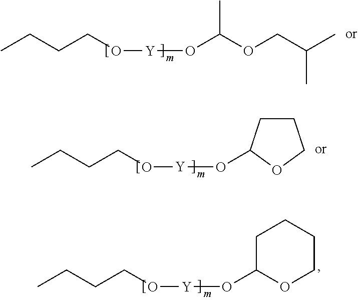

where Y is 1,2-propylene and m is an integer in the range from 9 to 35.

In a further preferred compound of the formula (I), n is 2, R¹ is H, R⁴ is a polyoxypropylene radical having an average molecular weight in the range from 650 to 4′000 g/mol, especially 650 to 2′000 g/mol, and either R² and R³ together are 1,3-propylene or 1,4-butylene or R² is methyl and R³ is methyl, ethyl, isopropyl, butyl, isobutyl, tert-butyl, hexyl, 2-ethylhexyl, allyl, cyclohexyl, benzyl or phenyl, preferably methyl, ethyl, isopropyl, butyl or isobutyl, especially isobutyl.

Such a compound of the formula (I) is particularly easily obtainable and enables curable compositions having a particularly low level of migration effects. It especially has the formula

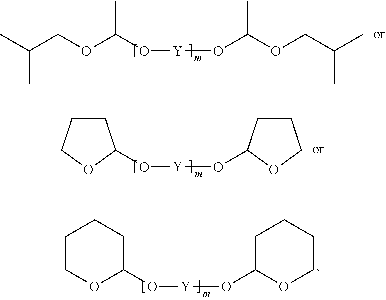

where Y is 1,2-propylene and m is an integer in the range from 10 to 35.

The compound of the formula (I) containing acetal groups is obtainable in a formal sense from the condensation of at least one aldehyde or ketone of the formula (II) with at least one alcohol of the formula (III) and at least one alcohol of the formula (IV).

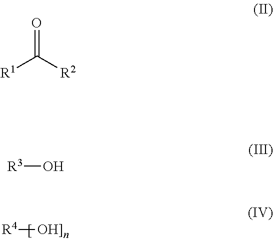

In the formulae (II), (III) and (IV), R¹, R², R³, R⁴ and n have the definitions already given.

A preferred aldehyde or ketone of the formula (II) is formaldehyde, acetaldehyde, propionaldehyde, butyraldehyde, isobutyraldehyde, valeraldehyde, isovaleraldehyde, hexanal, 2-ethylhexanal, cyclohexylcarboxaldehyde or benzaldehyde, or acetone, methyl ethyl ketone, methyl isobutyl ketone, cyclohexanone or acetophenone, especially formaldehyde or acetaldehyde.

For compounds of the formula (I) in which n is 1 and R³ and R⁴ are each identical radicals, the alcohols of the formulae (III) and (IV) used are preferably the same alcohol in each case, especially isononanol, isodecanol, lauryl alcohol, 2-phenoxyethanol, 2-phenoxypropanol, 2-benzyloxyethanol, dipropylene glycol methyl ether, dipropylene glycol butyl ether or alcohol-started polyoxypropylenemonools having an average molecular weight in the range from 300 to 2′000 g/mol.

Butanol-started polyoxypropylenemonools are commercially available, for example Ucon® LB 65 or Synalox® 100-20B, Synalox® 100-40B or Synalox® 100-85B (all from DowDuPont).

Compounds of the formula (I) in which R³ and R⁴ are not identical radicals can especially be prepared by reacting at least one alcohol of the formula (IV) with at least one vinyl ether of the formula (V)

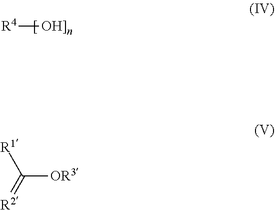

where
R^{1′} is H or methyl,
R^{2′} is an alkylidene radical having 1 to 7 carbon atoms,
R^{3′} is an alkyl or aryl radical having 1 to 8 carbon atoms,
where R^{1′} and R^{2′} may also together be an optionally substituted 1,4-butylidenediyl or 1,5-pentylidenediyl radical and R^{2′} and R^{3′} may also together be a 1,3-propylidenediyl or 1,4-butylidenediyl radical.

Preferably, R^{2′} is an alkylidene radical having 1 to 4 carbon atoms, especially methylidene, or R^{2′} and R^{3′} together are 1,3-propylidenediyl or 1,4-butylidenediyl.

Suitable alcohols of the formula (IV) are especially butanol-started polyoxypropylenemonools having an average molecular weight in the range from 650 to 2′000 g/mol, or polyoxypropylenediols having an average molecular weight in the range from 650 to 4′000 g/mol, especially 650 to 2′000 g/mol, or trimethylolpropane- or glycerol-started polyoxypropylenetriols having an average molecular weight in the range from 1000 bis 4′000 g/mol.

A suitable vinyl ether of the formula (V) is especially methyl vinyl ether, ethyl vinyl ether, propyl vinyl ether, isopropyl vinyl ether, butyl vinyl ether, isobutyl vinyl ether, tert-butyl vinyl ether, hexyl vinyl ether, 2-ethylhexyl vinyl ether, cyclohexyl vinyl ether, allyl vinyl ether, benzyl vinyl ether, phenyl vinyl ether, 1-propenyl methyl ether, 1-propenyl ethyl ether, isopropenyl methyl ether, isopropenyl ethyl ether, isopropenyl propyl ether, isopropenyl isopropyl ether, isopropenyl butyl ether, isopropenyl phenyl ether, 1-methoxycyclopentene (cyclopentenyl methyl ether), 1-ethoxycyclopentene (cyclopentenyl ethyl ether), 1-methoxycyclohexene (cyclohexenyl methyl ether), 1-ethoxycyclohexene (cyclohexenyl ethyl ether), 2,3-dihydrofuran, 3,4-dihydro-2H-pyran or 4-methyl-3,4-dihydro-2H-pyran.

Preference is given to methyl vinyl ether, ethyl vinyl ether, isopropyl vinyl ether, butyl vinyl ether, isobutyl vinyl ether, isopropenyl methyl ether, isopropenyl ethyl ether, 2,3-dihydrofuran or 3,4-dihydro-2H-pyran.

Most preferred is isobutyl vinyl ether, 2,3-dihydrofuran or 3,4-dihydro-2H-pyran. The reaction with isobutyl vinyl ether affords compounds of the formula (I) in which R¹ is H, R² is methyl and R³ is isobutyl.

The reaction with 2,3-dihydrofuran or 3,4-dihydro-2H-pyran affords compounds of the formula (I) in which R¹ is H and R² and R³ together are 1,3-propylene or 1,4-butylene.

It is likewise possible to prepare compounds of the formula (I) by transacetalization of at least one acetal of the formula

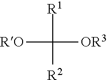

with at least one alcohol of the formula (IV), or by transacetalization of at least one acetal of the formula

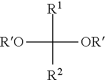

with at least one alcohol of the formula (III) and at least one alcohol of the formula (IV), wherein the alcohol R′OH is released and preferably removed by distillation. R¹ and R² here have the definitions already given. Preferably, R′ here is methyl or ethyl. A suitable acetal for a transacetalization is especially dimethoxymethane or diethoxymethane.

The reaction is preferably conducted in such a way that the reaction product formed is ultimately free of hydroxyl groups.

The reaction is preferably conducted in the presence of an acid as catalyst, especially hydrochloric acid, sulfuric acid, phosphoric acid or a sulfonic acid, optionally in the form of an acidic ion exchange resin.

The curable composition additionally contains at least one basic catalyst. The basic catalyst preferably has a pKₐ of the conjugate acid of at least 9, more preferably at least 10, especially at least 11. Such a catalyst is able to very efficiently accelerate the curing of organic polymers having silane and/or isocyanate groups.

Preferred basic catalysts are nitrogen or phosphorus compounds having a pKₐ of the conjugate acid of at least 9, more preferably at least 10, especially at least 11, especially amines, amidines, guanidines, biguanides, phosphines, phosphites, phosphazene bases or phosphatranes.

Preferred basic catalysts are
tertiary amines such as, in particular, triethylamine, triisopropylamine, N,N,N′,N′-tetramethylalkylenediamines, tris(3-dimethylaminopropyl)amine, 1,4-diazabicyclo[2.2.2]octane (DABCO), dimethylcyclohexylamine, 4-dimethylaminopyridine, 1,3,5-tris(3-(dimethylamino)propyl)hexahydrotriazine or tris-2,4,6-dimethylaminomethylphenol,
amines having primary and/or secondary amino groups, such as, in particular, butylamine, dibutylamine, tributylamine, hexylamine, dihexylamine, cyclohexylamine, octylamine, 2-ethylhexylamine, laurylamine, stearylamine, ethylenediamine, butylenediamine, hexamethylenediamine, polyetheramines such as 2-aminopropyl-terminated glycols as obtainable, for example, under the Jeffamine® trade name (from Huntsman), or aminosilanes such as, in particular, 3-aminopropyltrimethoxysilane, 3-aminopropyldimethoxymethylsilane, 3-aminopropyltriethoxysilane, 3-aminopropyldiethoxymethylsilane, 3-(2-aminoethyl)aminopropyltrimethoxysilane, 3-(2-aminoethyl)aminopropyltriethoxysilane or N-(2-aminoethyl)-N′-[3-(trimethoxysilyl)propyl]ethylenediamine, with amines having primary and/or secondary amino groups being suitable as catalyst solely for compositions free of isocyanate groups,
amidines such as, in particular, 1,8-diazabicyclo[5.4.0]undec-7-ene (DBU), 1,5-diazabicyclo[4.3.0]non-5-ene (DBN), 6-dibutylamino-1,8-diazabicyclo[5.4.0]undec-7-ene, N,N′-di-n-hexylacetamidine (DHA), 2-methyl-1,4,5,6-tetrahydropyrimidine, 1,2-dimethyl-1,4,5,6-tetrahydropyrimidine, 2,5,5-trimethyl-1,4,5,6-tetrahydropyrimidine, N-(3-trimethoxysilylpropyl)-4,5-dihydroimidazole, N-(3-triethoxysilylpropyl)-4,5-dihydroimidazole, 1-(3-dimethylaminopropyl)-2-methyl-1,4,5,6-tetrahydropyrimidine, 1-(3-aminopropyl)-2-methyl-1,4,5,6-tetrahydropyrimidine or reaction products thereof,
guanidines such as, in particular, 1-butylguanidine, 1,1-dimethylguanidine, 1,3-dimethylguanidine, 1,1,3,3-tetramethylguanidine (TMG), 2-(3-(trimethoxysilyl)propyl)-1,1,3,3-tetramethylguanidine, 2-(3-(methyldimethoxysilyl)propyl)-1,1,3,3-tetramethylguanidine, 2-(3-(triethoxysilyl)propyl)-1,1,3,3-tetramethylguanidine, 1,5,7-triazabicyclo[4.4.0]dec-5-ene (TBD), 7-methyl-1,5,7-triazabicyclo[4.4.0]dec-5-ene, 7-cyclohexyl-1,5,7-triazabicyclo[4.4.0]dec-5-ene, 1-phenylguanidine, 1-(o-tolyl)guanidine (OTG), 1,3-diphenylguanidine, 1,3-di(o-tolyl)guanidine, 2-guanidinobenzimidazole or guanidines from the reaction of monoamines, polyamines or aminosilanes with carbodiimides, especially dicyclohexylcarbodiimide or diisopropylcarbodiimide,
biguanides such as, in particular, biguanide, 1-butylbiguanide, 1,1-dimethylbiguanide, 1-butylbiguanide, 1-phenylbiguanide or 1-(o-tolyl)biguanide (OTBG),
phosphazene bases such as, in particular, the commercially available tert-butyliminotris(dimethylamino)phosphorane (phosphazene base P₁-t-Bu), tert-butyliminotripyrrolidinophosphorane (BTPP), tert-octyliminotris(dimethylamino)phosphorane (phosphazene base P₁-t-Oct), 1-ethyl-2,2,4,4,4-pentakis(dimethylamino)-2λ⁵,4λ⁵-catenadi(phosphazene) (phosphazene base P₂-Et), 1-tert-butyl-2,2,4,4,4-pentakis(dimethylamino)-2λ⁵,4λ⁵-catenadi(phosphazene) (phosphazene base P₂-t-Bu) or 2-tert-butylimino-2-diethylamino-1,3-dimethylperhydro-1,3,2-diazaphosphorine (BEMP).

The basic catalyst is more preferably an amidine or a guanidine, especially DBU, 1-(3-dimethylaminopropyl)-2-methyl-1,4,5,6-tetrahydropyrimidine, 1-(3-aminopropyl)-2-methyl-1,4,5,6-tetrahydropyrimidine or reaction products thereof, or a guanidine from the reaction of monoamines, polyamines or aminosilanes with dicyclohexylcarbodiimide or diisopropylcarbodiimide. Such a catalyst is easily obtainable and particularly active.

The curable composition preferably additionally contains one or more further constituents, especially selected from fillers, adhesion promoters, desiccants and further catalysts.

Suitable fillers are especially ground or precipitated calcium carbonates, optionally coated with fatty acids, especially stearates, barytes, quartz flours, quartz sands, dolomites, wollastonites, kaolins, calcined kaolins, sheet silicates, such as mica or talc, zeolites, aluminum hydroxides, magnesium hydroxides, silicas, including finely divided silicas from pyrolysis processes, industrially produced carbon blacks, graphite, metal powders, for example of aluminum, copper, iron, silver or steel, PVC powders or hollow beads. Preference is given to ground or precipitated calcium carbonates that have optionally been coated with fatty acids, especially stearates, calcined kaolins or industrially produced carbon blacks, and combinations of the aforementioned fillers.

The composition preferably has a content of fillers in the range from 10% to 60% by weight, especially 20% to 50% by weight.

Suitable adhesion promoters are especially aminosilanes such as, in particular, 3-aminopropyltrimethoxysilane, 3-aminopropyldimethoxymethylsilane, N-(2-aminoethyl)-3-aminopropyltrimethoxysilane, N-(2-aminoethyl)-3-aminopropyldimethoxymethylsilane, N-(2-aminoethyl)-N′-[3-(trimethoxysilyl)propyl]ethylenediamine or the analogs thereof with ethoxy in place of methoxy groups, and also N-phenyl-, N-cyclohexyl- or N-alkylaminosilanes, mercaptosilanes, epoxysilanes, (meth)acrylosilanes, anhydridosilanes, carbamatosilanes, alkylsilanes or iminosilanes, oligomeric forms of these silanes, adducts formed from primary aminosilanes with epoxysilanes or (meth)acrylosilanes or anhydridosilanes, amino-functional alkylsilsesquioxanes, especially amino-functional methylsilsesquioxane or amino-functional propylsilsesquioxane, or titanates.

Especially suitable as adhesion promoters for a composition containing isocyanate groups are epoxysilanes such as, in particular, 3-glycidoxypropyltrimethoxysilane or 3-glycidoxypropyltriethoxysilane, (meth)acrylosilanes, anhydridosilanes, carbamatosilanes, alkylsilanes or iminosilanes, or oligomeric forms of these silanes.

Suitable desiccants for compositions comprising polymers containing silane groups are especially tetraethoxysilane, vinyltrimethoxysilane, vinyltriethoxysilane or organoalkoxysilanes having a functional group in α position to the silane group, especially N-(methyldimethoxysilylmethyl)-O-methylcarbamate, (methacryloyloxymethyl)silanes, methoxymethylsilanes, orthoformic esters, calcium oxide or molecular sieve powders.

Suitable desiccants for compositions containing isocyanate groups are especially molecular sieve powders, calcium oxide, highly reactive isocyanates such as p-tosyl isocyanate, monomeric diisocyanates or orthoformic esters.

Suitable further catalysts are especially metal catalysts for the crosslinking of silane groups, especially compounds of tin, titanium, zirconium, aluminum or zinc. Preference is given to diorganotin(IV) compounds such as, in particular, dibutyltin diacetate, dibutyltin dilaurate, dibutyltin dineodecanoate, dibutyltin(IV) bis(acetylacetonate) or dioctyltin(IV) dilaurate, and also titanium(IV) or zirconium(IV) or aluminum(III) or zinc(II) complexes with, in particular, alkoxy, carboxylate, 1,3-diketonate, 1,3-ketoesterate or 1,3-ketoamidate ligands, especially organotitanates.

Suitable further catalysts are additionally catalysts for the reaction of isocyanate groups, especially organotin(IV) compounds, such as especially dibutyltin diacetate, dibutyltin dilaurate, dibutyltin dichloride, dibutyltin diacetylacetonate, dimethyltin dilaurate, dioctyltin diacetate, dioctyltin dilaurate or dioctyltin diacetylacetonate, complexes of bismuth(III) or zirconium(IV), especially with ligands selected from alkoxides, carboxylates, 1,3-diketonates, oxinate, 1,3-ketoesterates and 1,3-ketoamidates, or what are called “delayed action” catalysts, which are modifications of known metal or amine catalysts.

The curable composition may contain further constituents, especially the following auxiliaries and additives:
additional plasticizers, especially carboxylic esters such as phthalates, especially dioctyl phthalate, bis(2-ethylhexyl) phthalate, bis(3-propylheptyl) phthalate, diisononyl phthalate or diisodecyl phthalate, terephthalates, trimellitates, diesters of ortho-cyclohexanedicarboxylic acid, especially diisononyl cyclohexane-1,2-dicarboxylate, adipates, especially dioctyl adipate, azelates, sebacates, succinates or citrates, ethers or monocarboxylic esters of alcohols or glycols, especially methyl ethers, 2-ethylhexanoates or benzoates, and also fatty acid methyl or ethyl esters, also called “biodiesel”, natural or modified vegetable oils, especially rapeseed oil, soybean oil, epoxidized soybean oil or castor oil, organic phosphoric or sulfonic esters, sulfonamides, urethanes, high-boiling hydrocarbons, polybutenes, polyisobutylenes, polystyrenes or chloroparaffins;
solvents;
crosslinkers, especially latent hardeners for polymers containing isocyanate groups, such as, in particular, ketimines, aldimines or oxazolidines;
fibers, especially glass fibers, carbon fibers, metal fibers, ceramic fibers, polymer fibers, such as polyamide fibers or polyethylene fibers, or natural fibers, such as wool, cellulose, hemp or sisal;
dyes;
pigments, especially titanium dioxide or iron oxides;
rheology modifiers, especially urea compounds, sheet silicates such as bentonites, derivatives of castor oil, hydrogenated castor oil, polyamides, polyurethanes, fumed silicas, cellulose ethers or hydrophobically modified polyoxyethylenes;
natural resins, fats or oils, such as rosin, shellac, linseed oil, castor oil or soybean oil;
non-reactive polymers, especially homo- or copolymers of unsaturated monomers, especially from the group comprising ethylene, propylene, butylene, isobutylene, isoprene, vinyl acetate or alkyl (meth)acrylates, especially polyethylenes (PE), polypropylenes (PP), polyisobutylenes, ethylene-vinyl acetate copolymers (EVA) or atactic poly-α-olefins (APAO);
flame-retardant substances, especially the aluminum hydroxide or magnesium hydroxide fillers already mentioned, and also especially organic phosphoric acid esters, such as especially triethyl phosphate, tricresyl phosphate, triphenyl phosphate, diphenyl cresyl phosphate, isodecyl diphenyl phosphate, tris(1,3-dichloro-2-propyl) phosphate, tris(2-chloroethyl) phosphate, tris(2-ethylhexyl) phosphate, tris(chloroisopropyl) phosphate, tris(chloropropyl) phosphate, isopropylated triphenyl phosphate, mono-, bis- or tris(isopropylphenyl) phosphates of different degrees of isopropylation, resorcinol bis(diphenylphosphate), bisphenol A bis(diphenylphosphate) or ammonium polyphosphates;
additives, especially wetting agents, leveling agents, defoamers, deaerators, stabilizers against oxidation, heat, light or UV radiation, or biocides;
and other substances customarily used in curable compositions. It may be advisable to subject certain constituents to chemical or physical drying before mixing them into the composition.

The curable composition is preferably free of phthalates.

The curable composition is preferably largely free of solvents, “solvents” referring to volatile organic compounds having a boiling point below 250° C. at standard pressure and/or a vapor pressure of at least 10 Pa at 20° C. and standard pressure. The composition preferably contains less than 2% by weight, especially less than 1% by weight, of solvents. More preferably, the composition is entirely free of solvents. Such a composition is particularly advantageous from a toxicological and environmental point of view.

The curable composition preferably contains a content of compounds containing acetal groups and having a molecular weight of at least 280 g/mol, especially compounds of the formula (I), in the range from 1% to 50% by weight, more preferably 2% to 45% by weight, especially 5% to 40% by weight, most preferably 10% to 35% by weight.

Such a composition has good processibility and elastic properties.

The curable composition is preferably produced and stored under exclusion of moisture. In particular, it is storage-stable with exclusion of moisture in a suitable package or arrangement, such as, in particular, a bottle, a canister, a pouch, a bucket, a vat or a cartridge.

The curable composition may be in the form of a one-component composition or in the form of a multi-component, especially two-component, composition.

A composition referred to as a “one-component” composition is one in which all constituents of the composition are in the same container and which is storage-stable per se.

A composition referred to as a “two-component” composition is one in which the constituents of the composition are in two different components which are stored in separate containers and are not mixed with one another until shortly before or during the application of the composition.

The curable composition is preferably a one-component composition. Given suitable packaging and storage, it is storage-stable, typically over several months, up to one year or longer.

On application of the composition, the process of curing commences. This results in the cured composition.

In the case of a one-component composition, it is applied as such and then begins to cure under the influence of moisture or water. For acceleration of the curing, an accelerator component which contains or releases water and/or a catalyst can be mixed into the composition on application, or the composition, after application thereof, can be contacted with such an accelerator component. Such a composition is also referred to as “moisture-curing”.

In the case of a two-component composition, it is applied after the mixing of the two components and begins to cure by internal reaction, and the curing may be completed by the action of external moisture. The two components can be mixed continuously or batchwise with dynamic mixers or static mixers.

In the course of curing, silane groups react with one another under the influence of moisture. They can be hydrolyzed on contact with moisture to give silanol groups (Si—OH groups). Further silane groups can condense with silanol groups to give siloxane groups (Si—O—Si groups).

In the course of curing, isocyanate groups react under the influence of moisture with one another and/or with any further reactive groups present in the composition, especially hydroxyl groups or free amino groups. If latent hardeners are additionally present, these react under the influence of moisture with isocyanate groups.

As a result of these reactions, the composition ultimately cures.

In the case of curing by means of atmospheric humidity, the composition cures from the outside inward, at first forming a skin on the surface of the composition. The so-called skin time is a measure of the curing rate of the composition. The speed of curing is generally determined by various factors, for example the availability of water, the temperature and the catalysts and further ingredients present.

The moisture required for curing can also get into the composition additionally or entirely from one or more substrates to which the composition has been applied and/or can come from an accelerator component which is mixed into the composition on application or is contacted therewith after application, for example by painting or spraying.

The composition is preferably applied at ambient temperature, especially in the range from about 0 to 50° C., preferably in the range from 5 to 40° C.

The composition is preferably cured at ambient temperature.

The curable composition, by virtue of the compound containing acetal groups, has good processibility and storage stability. This means that the compound of the formula (I) does not trigger any reactions in the composition that lead to limited usability, nor does it show any tendency to separation during storage in the container. More particularly, the compound containing acetal groups does not cause any significant change in skin time or any unpleasant odors during the storage of the composition, as is often observed in the case of curable SMP compositions from the prior art. After the curing of the composition, the compound containing acetal groups remains in the composition, where it exerts an elastifying effect, does not have a tendency to migration effects and does not cause any problems with odor or fogging.

The composition is suitable for a multitude of uses.

The composition is preferably an elastic adhesive or sealant or an elastic coating.

The composition is suitable as an elastic adhesive and/or sealant for bonding and sealing applications, especially in the construction and manufacturing industries or in motor vehicle construction, especially for parquet bonding, installable component bonding, cavity sealing, assembly, module bonding, vehicle body bonding, window pane bonding or joint sealing.

Elastic bondings in motor vehicle construction are, for example, the bonded attachment of parts, such as plastic covers, trim strips, flanges, fenders, driver's cabins or other installable components, to the painted body of a motor vehicle, or the bonding of glass panes into the vehicle body, where the motor vehicles are especially automobiles, trucks, buses, rail vehicles or ships.

The composition is especially suitable as sealant for the elastic sealing of all kinds of joints, seams or cavities, especially of joints in construction, such as expansion joints or connection joints between structural components. A sealant having flexible properties is particularly suitable especially for the sealing of expansion joints in built structures.

As elastic coating, the composition is suitable for the protection of floors or walls, especially as coating of balconies, terraces, open spaces, bridges, parking levels, or for the sealing of roofs, especially flat roofs or slightly inclined roof areas or roof gardens, or in the interior of buildings for water sealing, for example beneath tiles or flagstones in plumbing units or kitchens, or as floor covering in kitchens, industrial buildings or manufacturing spaces, or as seal in collection tanks, channels, shafts or wastewater treatment plants, or for the protection of surfaces as varnish or seal, or as casting compound for cavity sealing, as seam seal or as protective coating for pipes, for example.

It can also be used for repair purposes as seal or coating, for example of leaking roof membranes or floor coverings no longer fit for purpose, or especially as repair compound for highly reactive spray seals.

For use as an elastic adhesive or sealant, the composition at room temperature preferably has a pasty consistency with pseudoplastic properties. A pasty sealant or adhesive of this kind is especially applied to a substrate from standard cartridges which are operated manually, with compressed air or with a battery, or from a vat or hobbock via a delivery pump or an extruder, optionally via an application robot.

For use as an elastic coating, the composition preferably has a liquid consistency at room temperature with self-leveling properties. It may be slightly thixotropic, such that the coating is applicable to sloping to vertical surfaces without flowing away immediately. It is especially applied by means of a roller or brush or by pouring-out and distribution by means, for example, of a roller, a scraper or a notched trowel. In one operation, typically a layer thickness in the range from 0.5 to 3 mm, especially 1.0 to 2.5 mm, is applied.

Suitable substrates which can be bonded or sealed or coated with the composition are especially
glass, glass ceramic, concrete, mortar, fiber cement, especially fiber cement boards, brick, tile, gypsum, especially gypsum boards, or natural stone, such as granite or marble;
repair or leveling compounds based on PCC (polymer-modified cement mortar) or ECC (epoxy resin-modified cement mortar);
metals or alloys, such as aluminum, copper, iron, steel, nonferrous metals, including surface-finished metals or alloys, such as zinc-plated or chromium-plated metals;
asphalt or bitumen;
leather, textiles, paper, wood, wood materials bonded with resins, such as phenolic, melamine or epoxy resins, resin/textile composites or further materials called polymer composites;
plastics, such as rigid and flexible PVC, polycarbonate, polystyrene, polyester, polyamide, PMMA, ABS, SAN, epoxy resins, phenolic resins, PUR, POM, TPO, PE, PP, EPM or EPDM, in each case untreated or surface-treated, for example by means of plasma, corona or flames;
fiber-reinforced plastics, such as carbon fiber-reinforced plastics (CFP), glass fiber-reinforced plastics (GFP) and sheet molding compounds (SMC);
insulation foams, especially made of EPS, XPS, PUR, PIR, rock wool, glass wool or foamed glass;
coated or painted substrates, especially painted tiles, coated concrete, powder-coated metals or alloys or painted metal sheets;
paints or varnishes, especially automotive topcoats.

If required, the substrates can be pretreated prior to application, especially by physical and/or chemical cleaning methods or the application of an activator or a primer.

It is possible to bond and/or seal two identical or two different substrates.

After the curing of the composition, a cured composition is obtained.

The invention further provides a cured composition from the curing of the curable composition described with water, especially in the form of air humidity.

The cured composition is elastic and has high extensibility. It preferably has an elongation at break of at least 50%, especially at least 100%, determined on dumbbell-shaped test specimens having a length of 75 mm, a bar length of 30 mm and a bar width of 4 mm with a thickness of 2 mm to DIN EN 53504 at a strain rate of 200 mm/min, as described in the examples.

The application and curing of the composition affords an article bonded or sealed or coated with the composition. This article may be a built structure or a part thereof, especially a built structure in civil engineering above or below ground, a bridge, a roof, a staircase or a facade, or it may be an industrial good or a consumer good, especially a window, a pipe, a rotor blade of a wind turbine, a domestic appliance or a mode of transport, such as especially an automobile, a bus, a truck, a rail vehicle, a ship, an aircraft or a helicopter, or an installable component thereof.

### EXAMPLES

Working examples are adduced hereinafter, which are intended to further elucidate the invention described. Of course, the invention is not limited to these described working examples.

“Standard climatic conditions” refer to a temperature of 23±1° C. and a relative air humidity of 50±5%.

Unless stated otherwise, the chemicals used were from Sigma-Aldrich.

1.) Preparation of Compounds Containing Acetal Groups:

The viscosity was measured with a thermostated Rheotec RC30 cone-plate viscometer (cone diameter 50 mm, cone angle 1°, cone tip-plate distance 0.05 mm, shear rate 10 s⁻¹).

Infrared spectra (FT-IR) were measured as undiluted films on a Nicolet iS5 FT-IR instrument from Thermo Scientific equipped with a horizontal ATR measurement unit with a diamond crystal. The absorption bands are reported in wavenumbers (cm⁻¹).

Compound V-1: Butanol-started polypropylene glycol with 1-(isobutoxy)epoxy end group and average molecular weight of about 850 g/mol 300.00 g of butanol-started polyoxypropylenemonool with average molecular weight 750 g/mol (Synalox® 100-20B, from DowDuPont) and 0.17 g of methanesulfonic acid (anhydrous) were initially charged in a round-bottom flask under nitrogen atmosphere. Then 41.16 g of isobutyl vinyl ether (stabilized with 0.1% potassium hydroxide) was slowly added dropwise while stirring, such that the temperature of the reaction mixture did not rise above 70° C., and then the mixture was stirred at 70° C. under a nitrogen atmosphere until no hydroxyl groups were detectable any longer by means of IR and GC spectrometry. Subsequently, 0.07 g of sodium methoxide was added and stirred in, followed by 0.06 g of acetic acid. Then the volatile constituents were removed from the reaction mixture, first at 80° C. and a reduced pressure of 5 mbar and then at 100° C. and 2 mbar. A clear, yellowish liquid having a viscosity of 97 mPa·s at 20° C. was obtained.

FT-IR: 2969, 2931, 2868, 1455, 1372, 1343, 1296, 1257, 1099, 1012, 924, 905, 867, 831.

Compound V-2: Butanol-started polypropylene glycol with tetrahydropyran-2-oxy end group and average molecular weight of about 840 g/mol Compound V-2 was prepared as described for compound V-1, except that 34.57 g of 3,4-dihydro-2H-pyran was used rather than 41.16 g of isobutyl vinyl ether. A clear, colorless liquid having a viscosity of 77 mPa·s at 20° C. was obtained.

FT-IR: 2967, 2931, 2867, 1454, 1372, 1343, 1297, 1260, 1099, 1021, 997, 925, 906, 869, 814.

Compound V-3: Butanol-started polypropylene glycol with tetrahydrofuran-2-oxy end group and average molecular weight of about 830 g/mol Compound V-3 was prepared as described for compound V-1, except that 28.81 g of 2,3-dihydrofuran was used rather than 41.16 g of isobutyl vinyl ether. A clear, colorless liquid having a viscosity of 64 mPa·s at 20° C. was obtained. FT-IR: 2969, 2931, 2867, 1455, 1372, 1343, 1296, 1258, 1099, 1035, 1010, 919, 865, 836.

Compound V-4: Butanol-started polypropylene glycol with 1-(isobutoxy)ethoxy end group and average molecular weight of about 1′200 g/mol 300.00 g of butanol-started polyoxypropylenemonool with average molecular weight 1′100 g/mol (Synalox® 100-40B, from DowDuPont) and 28.16 g of isobutyl vinyl ether (stabilized with 0.1% potassium hydroxide) were converted using 0.08 g of sodium methoxide as described for compound V-1. A clear, yellowish liquid having a viscosity of 207 mPa·s at 20° C. was obtained. FT-IR: 2969, 2931, 2868, 1455, 1372, 1344, 1296, 1257, 1099, 1012, 924, 906, 867, 831.

Compound V-5: Butanol-started polypropylene glycol with 1-(isobutoxy)ethoxy end group and average molecular weight of about 1′900 g/mol 300.00 g of butanol-started polyoxypropylenemonool with average molecular weight 1′800 g/mol (Synalox® 100-85B, from DowDuPont) and 17.33 g of isobutyl vinyl ether (stabilized with 0.1% potassium hydroxide) were converted using 0.09 g of sodium methoxide as described for compound V-1. A clear, yellowish liquid having a viscosity of 533 mPa·s at 20° C. was obtained. FT-IR: 2969, 2930, 2867, 1455, 1372, 1344, 1296, 1257, 1099, 1012, 924, 867, 832.

Compound V-6: Butanol-started polypropylene glycol with tetrahydropyran-2-oxy end group and average molecular weight of about 1′890 g/mol 300.00 g of butanol-started polyoxypropylenemonool with average molecular weight 1′800 g/mol (Synalox® 100-85B, from DowDuPont) and 14.55 g of 3,4-dihydro-2H-pyran rather than isobutyl vinyl ether were converted using 0.11 g of sodium methoxide as described for compound V-1. A clear, yellowish liquid having a viscosity of 412 mPa·s at 20° C. was obtained.

FT-IR: 2969, 2931, 2867, 1454, 1372, 1344, 1296, 1259, 1097, 1020, 925, 908, 869, 834.

Compound V-7: Butanol-started polypropylene glycol with tetrahydrofuran-2-oxy end group and average molecular weight of about 1′880 g/mol 300.00 g of butanol-started polyoxypropylenemonool with average molecular weight 1′800 g/mol (Synalox® 100-85B, from DowDuPont) and 12.13 g of 2,3-dihydro-2H-furan rather than isobutyl vinyl ether were converted using 0.11 g of sodium methoxide as described for compound V-1, except that the temperature of the reaction mixture in the course of addition of 2,3-dihydro-2H-furan was kept below 50° C. and then the mixture was stirred at 50 rather than 70° C. A clear, yellowish liquid having a viscosity of 347 mPa·s at 20° C. was obtained. FT-IR: 2969, 2930, 2867, 1455, 1372, 1344, 1296, 1257, 1097, 1011, 922, 866, 834.

Compound V-8: Polypropylene glycol with two 1-(isobutoxy)ethoxy end groups and average molecular weight of about 1′200 g/mol 300.00 g of polyoxypropylenediol with average molecular weight 1′000 g/mol (Voranol® P 1010, from DowDuPont) and 61.90 g of isobutyl vinyl ether (stabilized with 0.1% potassium hydroxide) were converted using 0.07 g of sodium methoxide as described for compound V-1. A clear, yellowish liquid having a viscosity of 711 mPa·s at 20° C. was obtained.

FT-IR: 2970, 2931, 2869, 1454, 1372, 1343, 1296, 1257, 1099, 1013, 984, 924, 903, 867, 830.

Compound V-9: Polypropylene glycol with two 1-(isobutoxy)ethoxy end groups and average molecular weight of about 2′200 g/mol 300.00 g of polyoxypropylenediol with average molecular weight 2′000 g/mol (Voranol® 2000 L, from DowDuPont) and 39.95 g of isobutyl vinyl ether (stabilized with 0.1% potassium hydroxide) were converted using 0.08 g of sodium methoxide as described for compound V-1. A clear, yellowish liquid having a viscosity of 1149 mPa·s at 20° C. was obtained.

FT-IR: 2970, 2930, 2868, 1454, 1372, 1343, 1296, 1257, 1099, 1012, 924, 906, 867, 831.

2.) Commercial Substances Used and Abbreviations Thereof:
DPEF: di(2-phenoxyethyl) formal (Desavin®, from Covestro)
DIDP: diisodecyl phthalate (Palatinol® 10-P, from BASF)
DINP: diisononyl phthalate (Palatinol® N, from BASF)
DINCH: diisononyl cyclohexane-1,2-dicarboxylate (Hexamoll® DINCH, from BASF)
DOA: di(2-ethylhexyl) adipate (Adimoll® DO, from Lanxess)
TXIB: 1-isopropyl-2,2-dimethyltrimethylene diisobutyrate (Eastman TXIB™, from Eastman Chemical)
IsoSDE: isosorbide diester (Polysorb® ID-37, from Roquette Freres)
DPGDB: dipropylene glycol dibenzoate (Benzoflex® 9-88, from Eastman Chemical)
PAS: phenyl C₁₀-C₂₁-alkylsulfonate (Mesamoll®, from Lanxess)
TOF: tris(2-ethylhexyl) phosphate (Disflamoll® TOF, from Lanxess)
DPO: 2-ethylhexyl diphenylphosphate (Disflamoll® DPO, from Lanxess)
BBSA: N-butylbenzenesulfonamide (Proviplast® 024, from Proviron)
ESBO: epoxidized soybean oil (Merginat® ESBO, from HOBUM Oleochemicals)
PPG400: polypropylene glycol with average molecular weight about 400 g/mol (Voranol® P 400, from DowDuPont)
Castor oil: castor oil (Alberdingk® castor oil DIN quality, from Alberdingk Boley)
DME500: polyethylene glycol dimethyl ether with average molecular weight about 500 g/mol (Polyglycol DME 500, from Clariant)
IBAY: bis(ethylacetoacetato)diisobutoxytitanium(IV) (Tyzor® IBAY, from Dorf Ketal)
DBU: 1,8-diazabicyclo[5.4.0]undec-7-ene (Lupragen® N 700, from BASF)
AMMO 3-aminopropyltrimethoxysilane (Silquest® A-1110, from Momentive)
DAMO 3-(2-aminoethyl)aminopropyltrimethoxysilane (Silquest® A-1120, from Momentive)
Chalk: Omyacarb® 5-GU (from Omya)
Carbon Monarch® 570 (from Cabot) black:
Silica: fumed silica (Aerosil® R 972, from Evonik)

3.) Preparation of Organic Polymers Containing Silane Groups and/or Isocyanate Groups:

Polymer P1: (Polyether Containing Silane Groups)

With exclusion of moisture, 1000 g of Acclaim® 12200 polyol (polyoxypropylenediol having a low level of unsaturation, from Covestro; OH number 11.0 mg KOH/g), 43.6 g of isophorone diisocyanate (IPDI; Vestanat® IPDI, from Evonik) and 0.1 g of bismuth tris(neodecanoate) (10% by weight in diisodecyl phthalate) were heated up to 90° C. while stirring constantly and left at this temperature until the content of free isocyanate groups determined by titrimetry had reached a stable value of 0.7% by weight. Subsequently, 63.0 g of diethyl N-(3-trimethoxysilylpropyl)aminosuccinate (adduct of 3-aminopropyltrimethoxysilane and diethyl maleate; prepared as per U.S. Pat. No. 5,364,955) was mixed in and the mixture was stirred at 90° C. until it was no longer possible to detect any free isocyanate by FT-IR spectroscopy. The polyether containing trimethoxysilane groups obtained in this way was cooled down to room temperature and stored with exclusion of moisture.

Polymer P2: (Polyether Containing Silane Groups)

With exclusion of moisture, 720.0 g of Acclaim® 12200, 34.5 g of isophorone diisocyanate (Vestanat® IPDI, from Evonik), 80.0 g of diisononyl cyclohexane-1,2-dicarboxylate (Hexamoll® DINCH, from BASF) and 0.5 g of bismuth tris(neodecanoate) solution (10% by weight in diisononyl cyclohexane-1,2-dicarboxylate) were heated up to 90° C. while stirring constantly and left at this temperature until the content of free isocyanate groups determined by titrimetry had reached a stable value of 0.73% by weight. Subsequently, 49.1 g of N-(3-triethoxysilylpropyl)-2-hydroxypropanamide, prepared as described below, was added and the mixture was stirred under a nitrogen atmosphere at 80° C. until no isocyanate groups were detectable any longer by means of IR spectroscopy (about 2 hours). The polyether containing triethoxysilane groups obtained in this way was cooled down to room temperature and stored with exclusion of moisture.

N-(3-Triethoxysilylpropyl)-2-hydroxypropanamide was prepared by mixing 20.00 g of 3-aminopropyltriethoxysilane and 6.71 g (46.6 mmol) of L-lactide and stirring under a nitrogen atmosphere at 80° C. for 3 h until no further reaction progress was detected by means of IR spectroscopy, and the crude product was then aftertreated at 60° C. and about 10 mbar for 15 min. A colorless liquid product was obtained.

Polymer P3: (Polymer Containing Isocyanate Groups)

With exclusion of moisture, 590 g of Acclaim® 4200 (polyoxypropylenediol, from Covestro; OH number 28.5 mg KOH/g), 1180 g of Caradol® MD34-02 (polyoxypropylenepolyoxyethylenetriol, from Shell; OH number 35.0 mg KOH/g) and 230 g of isophorone diisocyanate (Vestanat® IPDI, from Evonik) were reacted by a known method at 80° C. to give an NCO-terminated polyurethane polymer which was liquid at room temperature and had a content of free isocyanate groups of 2.10% by weight.

4. Production of Curable Compositions:

Compositions Z1 to Z16: (SMP Compositions)

For each composition, the ingredients specified in table 1 were mixed in the amounts specified (in parts by weight) by means of a centrifugal mixer (SpeedMixer™ DAC 150, FlackTek Inc.) with exclusion of moisture at 3000 rpm for one minute and stored with exclusion of moisture.

Each composition was tested for skin time and viscosity, in fresh form (one hour after production) and after a storage time of 7 days in a closed container in an air circulation oven heated to 60° C. The skin time constitutes a measure of the curing rate, and a low viscosity enables good application properties.

The skin time (ST) was determined by applying a few grams of the composition to cardboard in a layer thickness of about 2 mm and, under standard climatic conditions, determining the time until, when the surface of the composition was gently tapped by means of an LDPE pipette, there were for the first time no residues remaining any longer on the pipette. The skin time was determined in the fresh state and in the stored state. A change of less than 25% was rated as “good”, of 25% to 100% as “average”, and of more than 100% as “poor”. Viscosity was measured as described above at 20° C. in the fresh state and in the stored state. A change of less than 100% was rated as “good”, of 100% to 200% as “average”, and of more than 200% as “poor”.

The results are reported in table 1.

The compositions labeled with (Ref) are comparative examples.

TABLE 1
Composition (in parts by weight) and properties of Z1 to Z16.

| | | | Z2 | Z3 | Z4 | Z5 | Z6 |
|---|---|---|---|---|---|---|---|
| Composition | | Z1 | (Ref.) | (Ref.) | (Ref.) | (Ref.) | (Ref.) |
| Polymer P1 | | 90.00 | 90.00 | 90.00 | 90.00 | 90.00 | 90.00 |
| Plasticizer | | DPEF | — | DIDP | DINCH | DOA | TXIB |
| | | 10.00 | | 10.00 | 10.00 | 10.00 | 10.00 |
| IBAY | | 1.50 | 1.50 | 1.50 | 1.50 | 1.50 | 1.50 |
| DBU | | 0.15 | 0.15 | 0.15 | 0.15 | 0.15 | 0.15 |
| DAMO | | 1.00 | 1.00 | 1.00 | — | — | 1.00 |
| AMMO | | — | — | — | 1.00 | 1.00 | — |
| ST | fresh | 17′ | 15′ | 17′ | 24′ | 11′ | 15′ |
| | stored | 14′ | 13′ | 28′ | 15′ | 73′ | 17′ |
| | Change | good | good | average | average | poor | good |
| Viscosity | fresh | 75 | 114 | 80 | 72 | 60 | 67 |
| [Pa · s] | stored | 127 | 141 | 100 | 132 | 82 | 280 |
| | Change | good | good | good | good | good | poor |
| | | Z7 | Z8 | Z9 | Z10 | Z11 | Z12 |
| Composition | | (Ref.) | (Ref.) | (Ref.) | (Ref.) | (Ref.) | (Ref.) |
| Polymer P1 | | 90.00 | 90.00 | 90.00 | 90.00 | 90.00 | 90.00 |
| Plasticizer | | IsoSDE | DPGDB | PAS | TOF | DPO | BBSA |
| | | 10.00 | 10.00 | 10.00 | 10.00 | 10.00 | 10.00 |
| IBAY | | 1.50 | 1.50 | 1.50 | 1.50 | 1.50 | 1.50 |
| DBU | | 0.15 | 0.15 | 0.15 | 0.15 | 0.15 | 0.15 |
| DAMO | | 1.00 | 1.00 | — | — | — | 1.00 |
| AMMO | | — | — | 1.00 | 1.00 | 1.00 | — |
| ST | fresh | 20′ | 16′ | 11′ | 10′ | 14′ | 17′ |
| | stored | 9′ | 13′ | 40′ | 17′ | >12 h | 20′ |
| | Change | average | good | poor | average | poor | good |
| Viscosity | fresh | 96 | 109 | 74 | 57 | 59 | 114 |
| [Pa · s] | stored | 279 | 330 | 138 | 138 | 99 | 315 |
| | Change | average | poor | good | average | good | average |

| | | Z13 | Z14 | Z15 | Z16 |
|---|---|---|---|---|---|
| Composition | | (Ref.) | (Ref.) | (Ref.) | (Ref.) |
| Polymer P1 | | 90.00 | 90.00 | 90.00 | 90.00 |
| Plasticizer | | ESBO | PPG400 | Castor oil | DME500 |
| | | 10.00 | 10.00 | 10.00 | 10.00 |
| IBAY | | 1.50 | 1.50 | 1.50 | 1.50 |
| DBU | | 0.15 | 0.15 | 0.15 | 0.15 |
| DAMO | | 1.00 | 1.00 | 1.00 | 1.00 |
| AMMO | | — | — | — | — |
| ST | fresh | 15′ | 22′ | 15′ | 15′ |
| | stored | 49′ | 13′ | 80′ | 20′ |
| | Change | poor | average | poor | average |
| Viscosity | fresh | 96 | 128 | 90 | 75 |
| [Pa · s] | stored | 139 | 405 | 292 | 93 |
| | Change | good | poor | poor | good |

Compositions Z17 to Z24: (SMP Compositions)

For each composition, 25.1 parts by weight (PW) of polymer P1, 25.1 PW of the plasticizer specified in table 2, 1.0 PW of vinyltrimethoxysilane, 12.4 PW of precipitated, stearate-coated chalk, 35.1 PW of chalk, 1.0 PW of DAMO, 0.2 PW of DBU and 0.05 PW of IBAY were mixed as described for composition Z1 and stored with exclusion of moisture.

Each composition was tested for skin time and viscosity as described for composition Z1. For the change in viscosity, a change of less than 50% was rated as “good”, of 50% to 100% as “average”, and of more than 100% as “poor”.

The odor of the uncured material was tested in the fresh state and after storage in a closed container at 60° C. for 7 days by smelling by nose at a distance of 10 cm. It is reported as “weak”, “average” or “strong”.

To determine the mechanical properties, each composition was applied to a PTFE-coated film to give a film of thickness 2 mm and stored under standard climatic conditions for 7 days, and a few dumbbells having a length of 75 mm with a bar length of 30 mm and a bar width of 4 mm were punched out of the film and these were tested in accordance with DIN EN 53504 at a strain rate of 200 mm/min for tensile strength (breaking force), elongation at break, and 50% modulus of elasticity (at 0.5-50% elongation). These results are reported as “SCC”.

Resistance to heat in the cured state was tested by storing films of thickness 2 mm that had been cured under standard climatic conditions for 7 days, produced as described above, in an air circulation oven at 60° C. or at 100° C. for 7 days, and then determining tensile strength, elongation at break and 50% modulus of elasticity as described above. These results are reported as “7 d 60° C.” and “7 d 100° C.” respectively.

In addition, the appearance of these films before and after storage at 60° C. was assessed visually, identified as “SCC” and “7 d 60° C.” respectively. “Nice” was used to describe an even film with a nontacky surface without blisters. “Greasy” was used to describe a film on the surface of which an oily film had formed as a result of plasticizer migration.

The results are reported in table 2.

The compositions labeled with (Ref) are comparative examples.

TABLE 2
Composition and properties of Z17 to Z24.

| | | | Z18 | Z19 | Z20 |
|---|---|---|---|---|---|
| Composition | | Z17 | (Ref.) | (Ref.) | (Ref.) |
| Plasticizer | | DPEF | DINP | DINCH | DOA |
| ST | fresh | 23′ | 22′ | 25′ | 23′ |
| | stored | 20′ | 28′ | 32′ | 32′ |
| | Change | good | average | average | average |
| Viscosity | fresh | 40 | 30 | 27 | 12 |
| [Pa · s] | stored | 39 | 42 | 25 | 12 |
| | Change | good | good | good | good |
| Odor | fresh | weak | weak | weak | weak |
| | stored | weak | strong | average | strong |
| Tensile | SCC | 1.61 | 1.63 | 1.47 | 1.65 |
| strength [MPa] | 7 d 60° C. | 1.32 | 1.37 | 1.18 | 1.31 |
| | 7 d 100° C. | 1.19 | 1.13 | 1.05 | 1.07 |
| Elongation at | SCC | 244 | 236 | 219 | 202 |
| break [%] | 7 d 60° C. | 240 | 245 | 187 | 204 |
| | 7 d 100° C. | 162 | 155 | 149 | 147 |
| Modulus of | SCC | 0.75 | 0.73 | 0.71 | 0.73 |
| elasticity | 7 d 60° C. | 0.78 | 0.76 | 0.73 | 0.69 |
| 50% [MPa] | 7 d 100° C. | 0.64 | 0.58 | 0.56 | 0.57 |
| Appearance | SCC | nice | nice | nice | nice |
| | 7 d 60° C. | nice | nice | greasy | nice |
| | | Z21 | Z22 | Z23 | Z24 |
| Composition | | (Ref.) | (Ref.) | (Ref.) | (Ref.) |
| Plasticizer | | PAS | BBSA | PPG400 | DME500 |
| ST | fresh | 21′ | 38′ | 107′ | 21′ |
| | stored | 70′ | 27′ | 143′ | 13′ |
| | Change | poor | average | average | average |
| Viscosity | fresh | 41 | 96 | 40 | 54 |
| [Pa · s] | stored | 50 | 179 | 82 | 67 |
| | Change | good | average | poor | good |
| Odor | fresh | weak | weak | weak | weak |
| | stored | average | average | stark | weak |
| Tensile | SCC | 1.63 | 1.60 | 1.56 | 1.41 |
| strength [MPa] | 7 d 60° C. | 1.35 | 1.48 | 1.22 | 1.19 |
| | 7 d 100° C. | n.m.¹ | n.m.¹ | n.m.¹ | n.m.¹ |
| Elongation at | SCC | 249 | 409 | 407 | 178 |
| break [%] | 7 d 60° C. | 300 | 415 | 435 | 222 |
| | 7 d 100° C. | n.m.¹ | n.m.¹ | n.m.¹ | n.m.¹ |
| Modulus of | SCC | 0.75 | 0.56 | 0.52 | 1.31 |
| elasticity | 7 d 60° C. | 0.72 | 1.19 | 0.39 | 1.19 |
| 50% [MPa] | 7 d 100° C. | n.m.¹ | n.m.¹ | n.m.¹ | n.m.¹ |
| Appearance | SCC | nice | nice | nice | greasy |
| | 7 d 60° C. | nice | nice | greasy | greasy |

¹not measurable, depolymerized

Compositions Z25 to Z33: (SMP Compositions)

For each composition, the ingredients specified in table 3 were mixed in the amounts specified (in parts by weight) by means of a centrifugal mixer (SpeedMixer™ DAC 150, FlackTek Inc.) with exclusion of moisture at 3000 rpm for one minute and stored with exclusion of moisture.

Each composition was tested as follows:

As a measure of the curing rate, the skin time (ST) was determined. For this purpose, a few grams of the composition were applied to cardboard in a layer thickness of about 2 mm and, under standard climatic conditions, the time until, when the surface of the composition was gently tapped by means of an LDPE pipette, there were for the first time no residues remaining any longer on the pipette was determined.

To determine the mechanical properties, each composition was applied to a PTFE-coated film to give a film of thickness 2 mm, stored under standard climatic conditions for 7 days, and then, as described for composition Z17, tested for tensile strength (breaking force), elongation at break, 5% modulus of elasticity (at 0.5-5% elongation), and 50% modulus of elasticity (at 0.5-50% elongation).

The odor of the uncured material was tested in the fresh state and after storage in a closed container at 60° C. for 7 days by smelling by nose at a distance of 10 cm. It is reported as “weak”, “average” or “strong”.

Appearance was assessed visually on the films produced. “Nice” was used to describe an even film with a nontacky surface without blisters.

As a measure of plasticizer migration, horizontal staining on cardboard was determined. For this purpose, each composition was applied to a piece of cardboard such that it had a round base area of diameter 15 mm and a height of 4 mm, and then stored under standard climatic conditions for 7 days and subsequently in an air circulation oven at 100° C. for 12 hours. Around each composition, thereafter, a dark oval stain had formed on the cardboard. The dimensions thereof (height and width) were measured and reported as migration (horizontal).

The results are reported in table 3.

The compositions labeled with (Ref.) are comparative examples.

TABLE 3
Composition (in parts by weight) and properties of Z-25 to Z-33.

| | | | | | | | | | | Z-33 |
|---|---|---|---|---|---|---|---|---|---|---|
| Composition | | Z-25 | Z-26 | Z-27 | Z-28 | Z-29 | Z-30 | Z-31 | Z-32 | (ref.) |
| Polymer P2 | | 30.3 | 30.3 | 30.3 | 30.3 | 30.3 | 30.3 | 30.3 | 30.3 | 30.3 |
| Compound | | V-2 | V-3 | V-4 | V-5 | V-6 | V-7 | V-8 | V-9 | DIDP |
| | | 34.1 | 34.1 | 34.1 | 34.1 | 34.1 | 34.1 | 34.1 | 34.1 | 34.1 |
| Chalk | | 30.3 | 30.3 | 30.3 | 30.3 | 30.3 | 30.3 | 30.3 | 30.3 | 30.3 |
| Silica | | 1.6 | 1.6 | 1.6 | 1.6 | 1.6 | 1.6 | 1.6 | 1.6 | 1.6 |
| Vinyltriethoxysilane | | 0.3 | 0.3 | 0.3 | 0.3 | 0.3 | 0.3 | 0.3 | 0.3 | 0.3 |
| IBAY | | 2.0 | 2.0 | 2.0 | 2.0 | 2.0 | 2.0 | 2.0 | 2.0 | 2.0 |
| DAMO | | 1.4 | 1.4 | 1.4 | 1.4 | 1.4 | 1.4 | 1.4 | 1.4 | 1.4 |
| ST | | 35 | 45 | 40 | 35 | 45 | 40 | 35 | 35 | 50 |
| Tensile strength | | 0.81 | 0.81 | 0.75 | 0.77 | 0.83 | 0.83 | 0.81 | 0.76 | 0.90 |
| [MPa] | | | | | | | | | | |
| Elongation at | | 134 | 132 | 128 | 133 | 147 | 141 | 137 | 129 | 149 |
| break [%] | | | | | | | | | | |
| Modulus of | | 0.28 | 0.29 | 0.24 | 0.26 | 0.24 | 0.27 | 0.27 | 0.25 | 0.34 |
| elasticity 5% [MPa] | | | | | | | | | | |
| Modulus of | | 0.38 | 0.38 | 0.37 | 0.36 | 0.35 | 0.36 | 0.37 | 0.37 | 0.39 |
| elasticity 50% | | | | | | | | | | |
| Appearance | | nice | nice | nice | nice | nice | nice | nice | nice | nice |
| Odor | fresh | weak | weak | weak | weak | weak | weak | weak | weak | weak |
| | stored | weak | weak | weak | weak | weak | weak | weak | weak | average |
| Migration | Height | 1 | 1 | 3 | 3 | 1 | 1 | 4 | 2 | 2 |
| (horizontal) | Width | 2 | 2 | 2 | 2 | 2 | 2 | 3 | 3 | 3 |
| [mm] | | | | | | | | | | |

Compositions Z34 to Z40: (Polyurethane compositions)

For each composition, the ingredients specified in table 4 were mixed in the amounts specified (in parts by weight) by means of a centrifugal mixer (SpeedMixer™ DAC 150, FlackTek Inc.) with exclusion of moisture at 3000 rpm for one minute and stored with exclusion of moisture.

Each composition was tested as follows:

Skin time (ST), tensile strength, elongation at break, 5% modulus of elasticity, 50% modulus of elasticity, appearance and odor were tested as described for composition Z-25.

As a measure of plasticizer migration, vertical staining on paper was determined. For this purpose, 30 g of the composition was introduced into a round vessel of diameter 45 mm that was open at the top (fill height about 17 mm) and then a piece of printer paper that had been rolled into a cylinder with a diameter of 26 mm and a height of 100 mm was placed into the fresh composition by the round side such that the rolled paper touched the base of the vessel and projected out of the composition at the top. This arrangement was stored under standard climatic conditions and observations were made after 3, 7 and 14 days as to whether staining had arisen as a result of liquid absorbed into the paper. The height of the ring-shaped stain was measured and reported as migration (vertical).

The results are reported in table 4.

The compositions labeled with (Ref.) are comparative examples.

TABLE 4
Composition (in parts by weight) and properties of Z-34 to Z-40.

| | | | | | | | | Z-40 |
|---|---|---|---|---|---|---|---|---|
| Composition | | Z-34 | Z-35 | Z-36 | Z-37 | Z-38 | Z-39 | (ref.) |
| Polymer P3 | | 30.4 | 30.4 | 30.4 | 30.4 | 30.4 | 30.4 | 30.4 |
| Compound | | V-1 | V-2 | V-3 | V-5 | V-6 | V-7 | DIDP |
| | | 35.2 | 35.2 | 35.2 | 35.2 | 35.2 | 35.2 | 35.2 |
| Chalk | | 30.4 | 30.4 | 30.4 | 30.4 | 30.4 | 30.4 | 30.4 |
| Silica | | 3.8 | 3.8 | 3.8 | 3.8 | 3.8 | 3.8 | 3.8 |
| Amidine catalyst¹ | | 0.2 | 0.2 | 0.2 | 0.2 | 0.2 | 0.2 | 0.2 |
| ST [min] | | 35 | 35 | 35 | 35 | 35 | 35 | 35 |
| Tensile strength | | 0.65 | 0.69 | 0.65 | 0.58 | 0.66 | 0.62 | 0.57 |
| [MPa] | | | | | | | | |
| Elongation at | | 331 | 334 | 324 | 234 | 366 | 300 | 269 |
| break [%] | | | | | | | | |
| Modulus of elasticity | | 0.43 | 0.30 | 0.33 | 0.49 | 0.39 | 0.44 | 0.36 |
| [MPa] 5% | 50% | 0.30 | 0.27 | 0.26 | 0.31 | 0.27 | 0.29 | 0.28 |
| Appearance | | nice | nice | nice | nice | nice | nice | nice |
| Odor | fresh | weak | weak | weak | weak | weak | weak | weak |
| | stored | weak | weak | weak | weak | weak | weak | strong |
| Migration | 3 d | 5 | 6 | 6 | 5 | 3 | 4 | 6 |
| (vertical) | 7 d | 5 | 6 | 6 | 8 | 3 | 7 | 6 |
| [mm] | 14 d | 5 | 6 | 6 | 10 | 3 | 9 | 6 |

¹1-(3-dimethylaminopropyl)-2-methyl-1,4,5,6-tetrahydropyrimidine (prepared like amidine A3 in WO 2016/166336), 25% by weight in xylene

1. A curable composition comprising
at least one organic polymer containing silane groups and/or isocyanate groups,
at least one compound containing acetal groups and having a molecular weight of at least 280 g/mol, and
at least one basic catalyst.

2. The composition as claimed in claim 1, wherein the organic polymer has an average molecular weight, determined by means of GPC against polystyrene as standard, in the range from 1000 to 30,000 g/mol.

3. The composition as claimed in claim 1, wherein the organic polymer is free of isocyanate groups.

4. The composition as claimed in claim 3, wherein the organic polymer is a polyether containing silane groups.

5. The composition as claimed in claim 1, wherein the organic polymer contains isocyanate groups and the composition has a total content of free isocyanate groups in the range from 0.2% to 2% by weight.

6. The composition as claimed in claim 1, wherein the compound containing acetal groups has a molecular weight in the range from 280 to 10,000 g/mol.

7. The composition as claimed in claim 1, wherein the compound containing acetal groups is a compound of the formula (I) 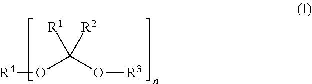
where
R¹ and R² are each independently H or an alkyl, cycloalkyl, aralkyl or aryl radical having 1 to 7 carbon atoms,
R³ is an alkyl, cycloalkyl or aralkyl radical optionally having ether groups and having 1 to 30 carbon atoms, or is a monovalent polyoxyalkylene radical having an average molecular weight in the range from 300 to 2,000 g/mol,
R⁴ is an n-valent alkyl, cycloalkyl or aralkyl radical optionally having ether groups and having 4 to 30 carbon atoms, or is an n-valent polyoxyalkylene radical having an average molecular weight in the range from 300 to 4,000 g/mol, and
n is 1 or 2 or 3,
where R¹ and R² may also together be an unbranched or branched alkylene radical having 4 to 12 carbon atoms and R² and R³ may also together be an unbranched or branched alkylene radical having 3 to 8 carbon atoms,
and wherein the compound of the formula (I) has a molecular weight of at least 280 g/mol.

8. The composition as claimed in claim 7, wherein n is 1, R¹ and R² are each H, and R³ and R⁴ are each identical radicals.

9. The composition as claimed in claim 7, wherein n is 1, R¹ is H, R⁴ is a 1-butanol-started polyoxypropylene radical having an average molecular weight in the range from 650 to 2,000 g/mol, and either R² and R³ together are 1,3-propylene or 1,4-butylene or R² is methyl and R³ is methyl, ethyl, isopropyl, butyl, isobutyl, tert-butyl, hexyl, 2-ethylhexyl, allyl, cyclohexyl, benzyl or phenyl.

10. The composition as claimed in claim 7, wherein n is 2, R¹ is H, R⁴ is a polyoxypropylene radical having an average molecular weight in the range from 650 to 4,000 g/mol, and either R² and R³ together are 1,3-propylene or 1,4-butylene or R² is methyl and R³ is methyl, ethyl, isopropyl, butyl, isobutyl, tert-butyl, hexyl, 2-ethylhexyl, allyl, cyclohexyl, benzyl or phenyl.

11. The composition as claimed in claim 1, wherein the basic catalyst is a nitrogen or phosphorus compound having a pKₐ of the conjugate acid of at least 9.

12. The composition as claimed in claim 1, wherein it has a content of fillers in the range from 10 to 60% by weight.

13. The composition as claimed in claim 1, wherein it is a one-component composition.

14. The composition as claimed in claim 1, wherein it is an elastic adhesive or a sealant or an elastic coating.

15. A cured composition obtained from the curing of the composition as claimed in claim 1 with water.
